(19) United States
(12) Patent Application Publication
(10) Pub. No.: US 2022/0085993 A1
(43) Pub. Date: Mar. 17, 2022

(54) RECONFIGURABLE SECRET KEY SPLITTING SIDE CHANNEL ATTACK RESISTANT RSA-4K ACCELERATOR

(71) Applicant: Intel Corporation, Santa Clara, CA (US)

(72) Inventors: RAGHAVAN KUMAR, Hillsboro, OR (US); SUDHIR SATPATHY, Hillsboro, OR (US); VIKRAM SURESH, Portland, OR (US); SANU MATHEW, Portland, OR (US)

(73) Assignee: Intel Corporation, Santa Clara, CA (US)

(21) Appl. No.: 17/019,864

(22) Filed: Sep. 14, 2020

(51) Int. Cl. H04L 9/08; H04L 9/32; H04L 9/30

(52) U.S. Cl. CPC H04L 9/0869; H04L 9/0891; H04L 9/302; H04L 9/3249

(57) ABSTRACT

An apparatus includes a processor to generate a random exponent having a fixed bit width, divide the random exponent into a pre-exponent portion and a post-exponent portion at a random bit position in the fixed bit width, and generate a cryptographic key using the pre-exponent portion and the post exponent portion

### BACKGROUND OF THE DESCRIPTION

Secure public-key encryption is a foundational operation underpinning the integrity of key-exchange and digital signatures. RSA is one of the prominent public-key encryption algorithms. While elliptical curve cryptography (ECC) offers higher security at shorter key lengths, the emergence of quantum computers has renewed interest in higher key-length RSA (e.g., greater than 4K bits). However, RSA implementations are susceptible to power and electromagnetic (EM) emission-based side-channel attacks (SCA), in which an attacker monitors current and EM radiation from RSA chip to decipher secret keys.

### BRIEF DESCRIPTION OF THE DRAWINGS

So that the manner in which the above recited features can be understood in detail, a more particular description, briefly summarized above, may be had by reference to embodiments, some of which are illustrated in the appended drawings. It is to be noted, however, that the appended drawings illustrate only typical embodiments and are therefore not to be considered limiting of its scope, for this disclosure may admit to other equally effective embodiments.

FIG. 1 is a schematic illustration of one embodiment of a computing device, according to examples.

FIGS. 2A-2C are schematic illustrations of a computing platform, according to embodiments.

FIG. 3 is a schematic illustration of various components of an RSA processor, according to embodiments.

FIG. 4 is a flow diagram illustrating operations in a method to implement a reconfigurable key-splitting SCA-resistant RSA accelerator, according to embodiments.

FIG. 5 is a flow diagram illustrating operations in a method to implement a reconfigurable key-splitting SCA-resistant RSA accelerator, according to embodiments.

FIG. 6 is a schematic illustration of a process for exponent magnitude and timing randomization, according to embodiments.

FIG. 7 is a schematic illustration of a process for address randomization, according to embodiments.

FIG. 8 is a set of graphs illustrating side channel attacks on an unprotected RSA processor.

FIG. 9 is a set of graphs illustrating side channel attacks on a protected RSA processor, according to embodiments.

FIG. 10 is a schematic illustration of an electronic device which may be adapted to implement non-ROM based IP firmware verification downloaded by host software, according to embodiments.

### DETAILED DESCRIPTION

In the following description, numerous specific details are set forth to provide a more thorough understanding of various embodiments. However, it will be apparent to one of skill in the art that various embodiments may be practiced without one or more of these specific details. In other instances, well-known features have not been described in order to avoid obscuring any of the embodiments.

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

Certain of the figures below detail example architectures and systems to implement embodiments of the above. In some embodiments, one or more hardware components and/or instructions described above are emulated as detailed below or implemented as software modules.

### Example Computing Devices and Platforms

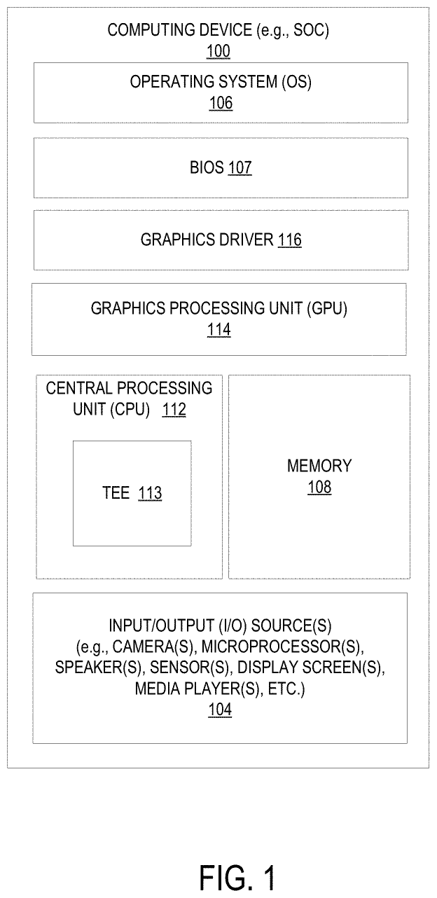

FIG. 1 is a schematic illustration of one embodiment of a computing device, according to examples. According to one embodiment, computing device 100 comprises a computer platform hosting an integrated circuit (“IC”), such as a system on a chip (“SoC” or “SOC”), integrating various hardware and/or software components of computing device 100 on a single chip. As illustrated, in one embodiment, computing device 100 may include any number and type of hardware and/or software components, such as (without limitation) graphics processing unit 114 (“GPU” or simply “graphics processor”), graphics driver 116 (also referred to as “GPU driver”, “graphics driver logic”, “driver logic”, user-mode driver (UMD), UMD, user-mode driver framework (UMDF), UMDF, or simply “driver”), central processing unit 112 (“CPU” or simply “application processor”), a trusted execution environment (TEE) 113, memory 108, network devices, drivers, or the like, as well as input/output (I/O) sources 104, such as touchscreens, touch panels, touch pads, virtual or regular keyboards, virtual or regular mice, ports, connectors, etc. Computing device 100 may include operating system (OS) 106 serving as an interface between hardware and/or physical resources of computing device 100 and a user and a basic input/output system (BIOS) 107 which may be implemented as firmware and reside in a non-volatile section of memory 108.

It is to be appreciated that a lesser or more equipped system than the example described above may be preferred for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or a combination thereof, such as firmware.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

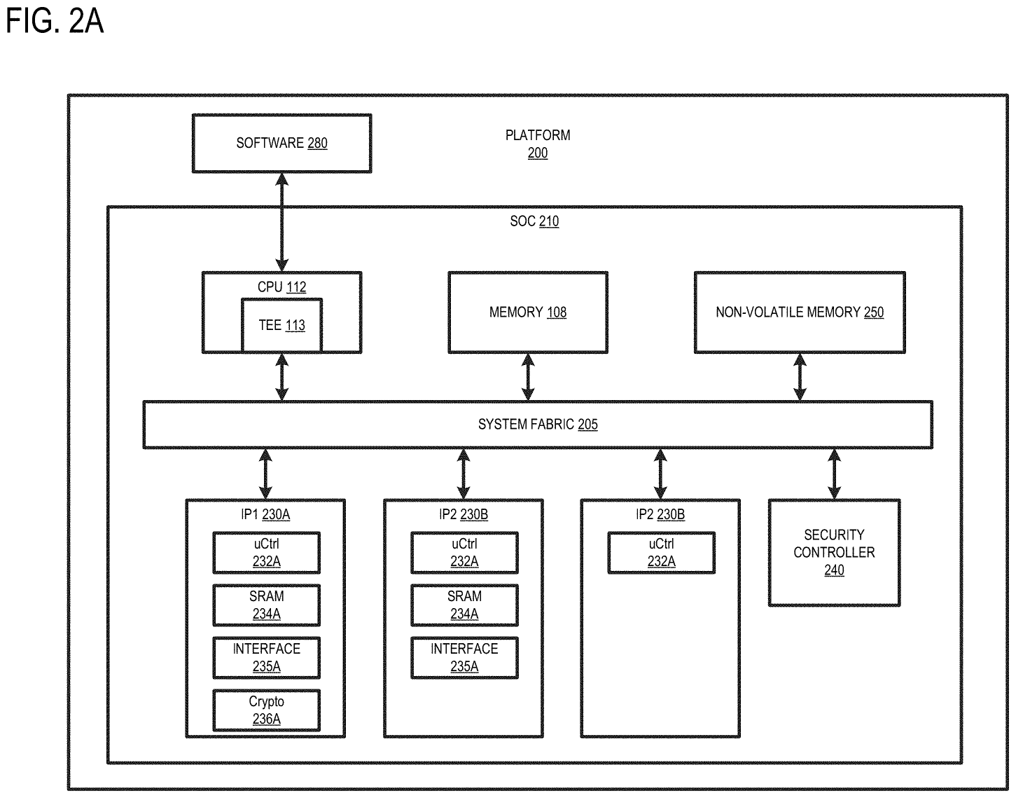

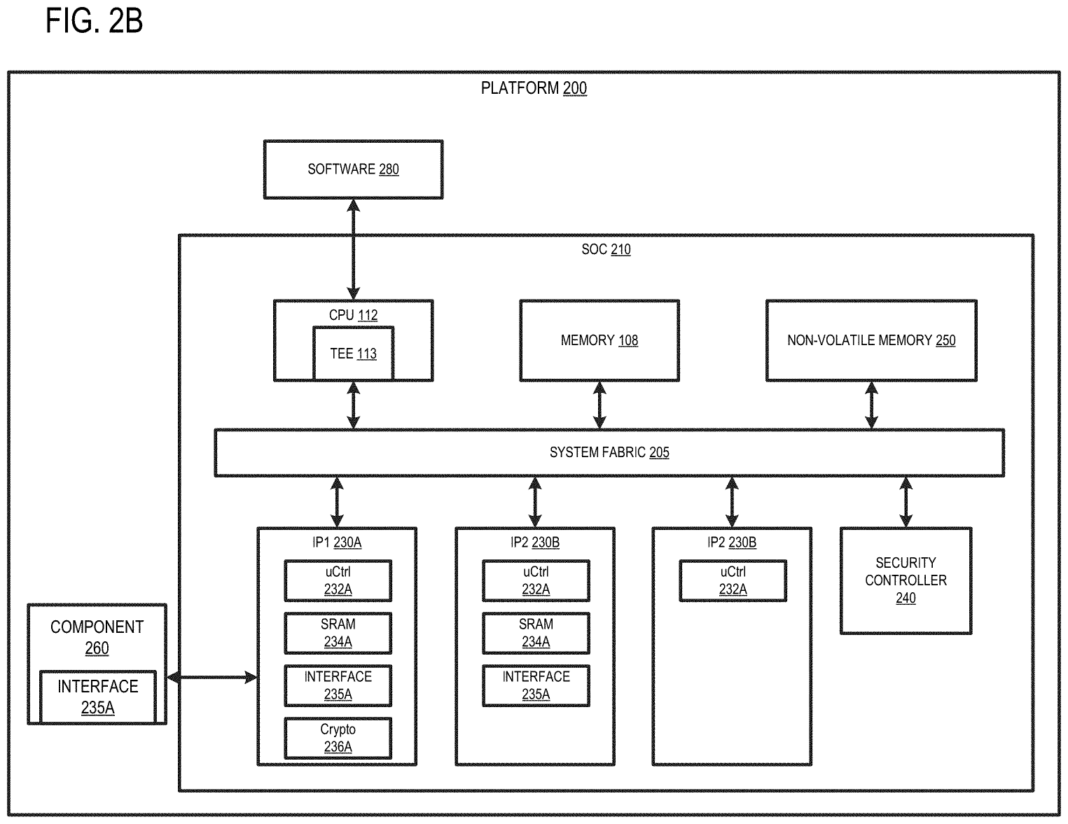

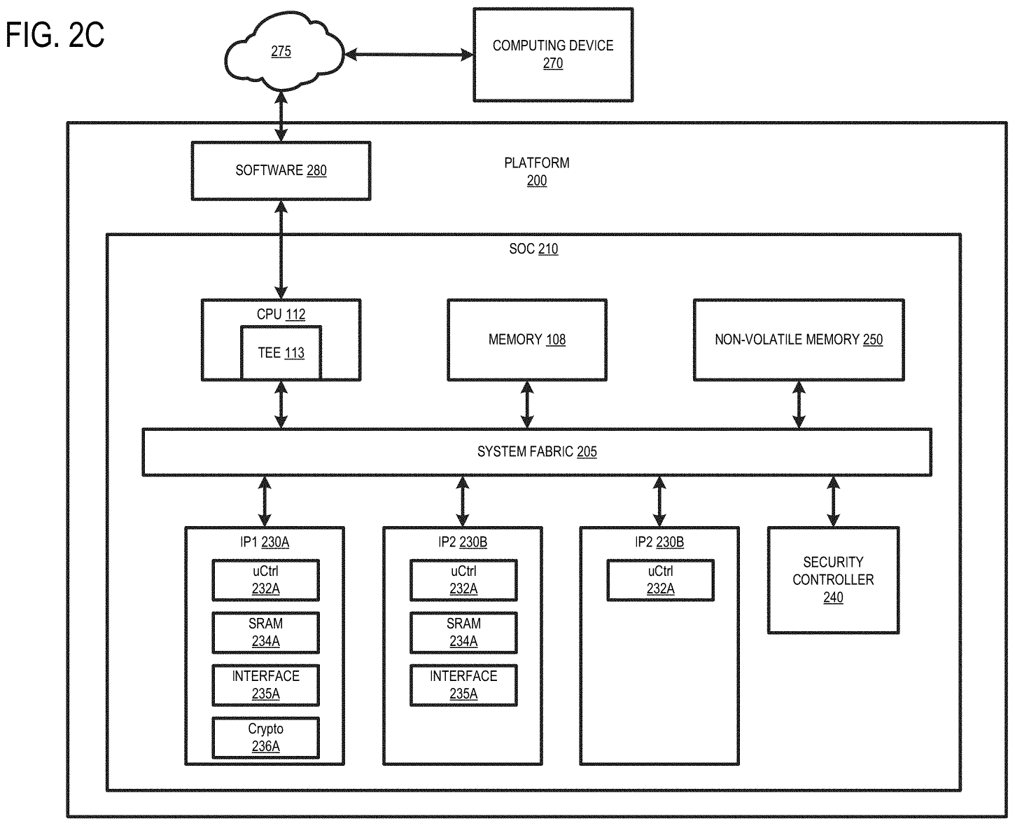

FIGS. 2A-2C are schematic illustrations of a computing platform, according to embodiments. In some examples the platform 200 may include a SOC 210 similar to computing device 100 discussed above. As shown in FIG. 2A, platform 200 includes SOC 210 communicatively coupled to one or more software components 280 via CPU 112. Additionally, SOC 210 includes other computing device components (e.g., memory 108) coupled via a system fabric 205. In one embodiment, system fabric 205 comprises an integrated on-chip system fabric (IOSF) to provide a standardized on-die interconnect protocol for coupling interconnect protocol (IP) agents 230 (e.g., IP blocks 230A and 230B) within SOC 210. In such an embodiment, the interconnect protocol provides a standardized interface to enable third parties to design logic such as IP agents 230 to be incorporated in SOC 210.

According to embodiment, IP agents 230 may include general purpose processors or microcontrollers 232 (e.g., in-order or out-of-order cores), fixed function units, graphics processors, I/O controllers, display controllers, etc., a SRAM 234, and may include a crypto module 236. In such an embodiment, each IP agent 230 includes a hardware interface 235 to provide standardization to enable the IP agent 230 to communicate with SOC 210 components. For example, in an embodiment in which IP agent 230 is a third-party visual processing unit (VPU), interface 235 provides a standardization to enable the VPU to access memory 108 via fabric 205.

SOC 210 also includes a security controller 240 that operates as a security engine to perform various security operations (e.g., security processing, cryptographic functions, etc.) for SOC 210. In one embodiment, security controller 240 comprises an IP agent 240 that is implemented to perform the security operations. Further, SOC 210 includes a non-volatile memory 250. Non-volatile memory 250 may be implemented as a Peripheral Component Interconnect Express (PCIe) storage drive, such as a solid state drives (SSD) or Non-Volatile Memory Express (NVMe) drives. In one embodiment, non-volatile memory 250 is implemented to store the platform 200 firmware. For example, non-volatile memory 250 stores boot (e.g., Basic Input/Output System (BIOS)) and device (e.g., IP agent 230 and security controller 240) firmware.

FIG. 2B illustrates another embodiment of platform 200 including a component 270 coupled to SOC 210 via IP 230A. In one embodiment, IP 230A operates as a bridge, such as a PCIe root port, that connects component 260 to SOC 210. In this embodiment, component 260 may be implemented as a PCIe device (e.g., switch or endpoint) that includes a hardware interface 235 to enable component 260 to communicate with SOC 210 components.

FIG. 2C illustrates yet another embodiment of platform 200 including a computing device 270 coupled to platform 200 via a cloud network 210. In this embodiment, computing device 270 comprises a cloud agent 275 that is provided access to SOC 210 via software 280.

### Example RSA Accelerator

As described briefly above, secure public-key encryption is a foundational operation underpinning the integrity of key-exchange and digital signatures. RSA is one of the prominent public-key encryption algorithms. While elliptical curve cryptography (ECC) offers higher security at shorter key lengths, the emergence of quantum computers has renewed interest in higher key-length RSA (e.g., greater than 4K bits). However, RSA implementations are susceptible to power and electromagnetic (EM) emission-based side-channel attacks, in which an attacker monitors current and EM radiation from RSA chip to decipher secret keys.

Conventional solutions to enhance SCA resistance in RSA applications involve key blinding and splitting. In the key blinding, the secret key is added with an integer multiple of modulus, where the integer is randomly sampled. In key splitting, the secret key is split to two exponents, where one of the exponents is randomly sampled. These key blinding and key splitting techniques suffer from significant real estate and/or performance overheads depending on the hardware implementation.

To address these and other issues this disclosure describes a SCA resistant RSA-4K modular exponentiation accelerator based on reconfigurable key splitting. In some examples, instead of splitting the secret key to two full word-size key exponents, a random sub-word size exponent is randomly sampled and subtracted from the secret key. The length of the sub-word exponent may also be randomized to further enhance SCA-resistance across vertical SCA attacks. The register file (RF) in the RSA accelerator also employs dynamic memory addressing through a non-linearly mapped physical address space to disrupt correlation between address space and memory accesses.

Subject matter described herein enables a SCA resistant modular exponentiation RSA-4K engine, which is a crucial component to enable public-key infrastructure in computing platforms such as offload crypto subsystem (OCS), quick assist technology (QAT), programmable FPGA platforms, where a secret key is used for digital signature generation, key exchange, SSL/TLS, etc. In some embodiments the accelerator includes a small reconfigurable random exponent derived from an on-chip pseudo-random number generator (PRNG). The RSA accelerator incurs less than a one percent area overhead increase compared to an unprotected RSA implementation. In some examples the accelerator uses non-linear substitution bytes (Sbox) based address mapping, which will be described in the product literature for direct memory access (DMA) to fill the memory contents.

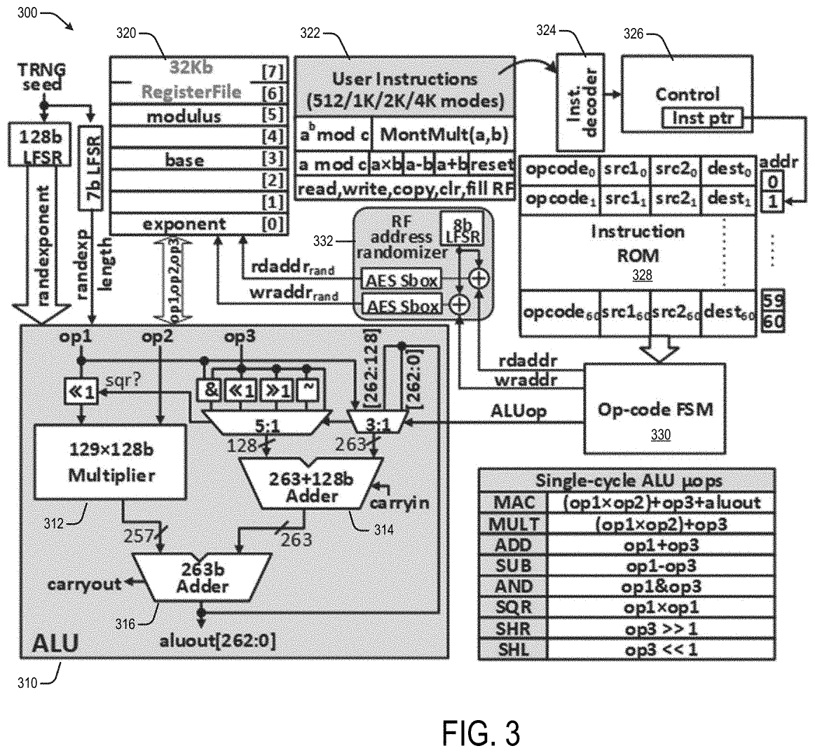

FIG. 3 is a schematic illustration of various components of an RSA processor, according to embodiments. Referring to FIG. 3, in one example RSA processor 300 comprises an arithmetic logic unit (ALU) 310 which in turn comprises a multiplier 312, an adder 314 and adder 316. RSA processor 300 further comprises a 32 KB register file 320, user instruction 322, instruction decoder 324, an instruction controller 326, instruction ROM 328, and an op-code finite state machine (FSM) 330.

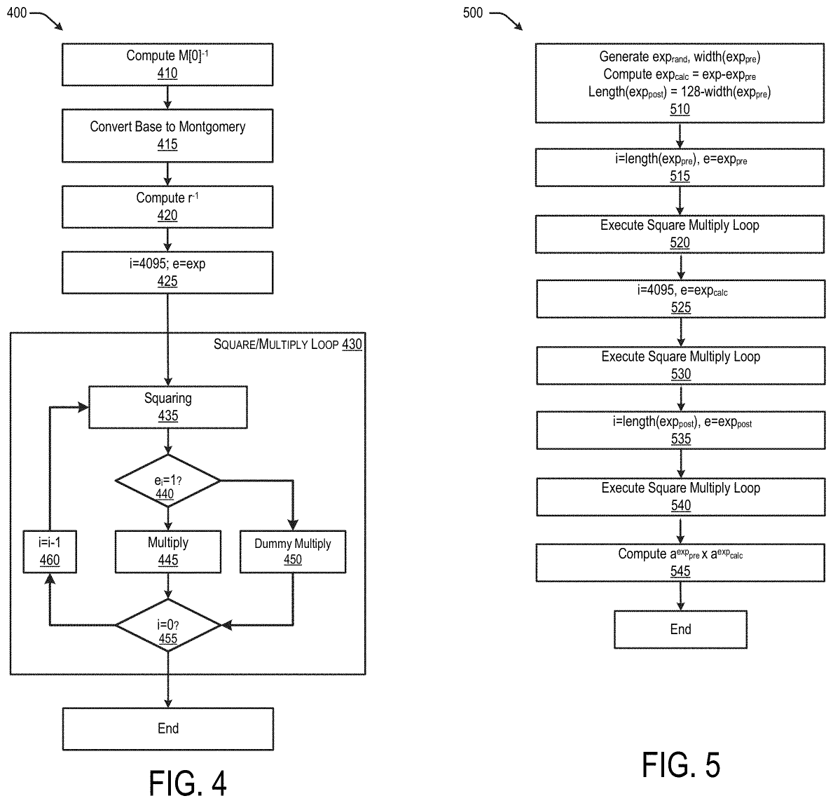

FIGS. 4-5 are flow diagrams illustrating operations in a method to implement a reconfigurable key-splitting SCA-resistant RSA accelerator, according to embodiments. Referring to FIG. 4, in operation, the exponentiation begins at operation 410 with Montgomery constants computation and at operation 415 a base conversion of the constants to Montgomery domain. At operation 420 the value r⁻¹ is computed and at operation 425 a counter (i) is set to 4095 and a value (e) is set to exp. In some examples, conventional unprotected implementations serially process each exponent bit in a square-multiply loop 430, which implements a squaring operation 435 and then, based on the value of eᵢ at operation 440, conditionally executes either a multiply operation 445 or a dummy-multiply operation 450. At operation 455 it is determined whether the counter i=0, and if not then control passes to operation 460 and the counter (i) is decremented and the loop repeats until the counter i=0.

In some examples, the invariant timeline of exponent processing along with its fixed magnitude allows an attacker to correlate current/EM trace magnitudes with the exponent bit being processed at each time-point. To address this issue an SCA-resistant implementation disrupts this time-invariance by using a random exponent exp_{rand}, to rand is obfuscate exponent processing timelines. In some examples the 128b exp_{rand} is further split into a pre exponent (expₚᵣₑ) and a post-exponent (expₚₒₛₜ) at a random bit position, which may be determined by a linear feedback shift register (LFSR), such that sub-exponent widths add up to 128. The main square-multiply-loop 430 may be interpolated between two additional loops operating on exponent values expₚᵣₑ and expₚₒₛₜ respectively. While the main loop latency remains constant at 4096 iterations, expₚᵣₑ and expₚₒₛₜ loop latencies are determined in real-time by the LFSR and therefore vary with every run. This ensures that start time of main exponent loop remains indeterminate, while guaranteeing constant loop iteration count of 4224, thereby mitigating timing based SCA attacks on the proposed countermeasure.

This is illustrated in FIG. 5. Referring to FIG. 5, at operation 510 a random exponent is generated and a width of the pre-exponent (expₚᵣₑ) is generated. Further the value (exp_{calc}) is determined and the length of (expₚₒₛₜ) is determined. At operation 515 a counter (i) is set to the length of the pre-exponent (expₚᵣₑ) and a parameter (e) is set to the value of (expₚᵣₑ). At operation 520 the square/multiply loop 430 is executed. At operation 525 a counter (i) is set to the length of 4095 and a parameter (e) is set to the value of (exp_{calc}). At operation 530 the square/multiply loop 430 is executed. At operation 535 a counter (i) is set to the length of the pre-exponent (expₚₒₛₜ) and a parameter (e) is set to the value of (expₚₒₛₜ). At operation 540 the square/multiply loop 430 is executed. At operation 545 the values of a^{exp}ₚᵣₑ is multiplied by the value of a^{exp}_{calc}.

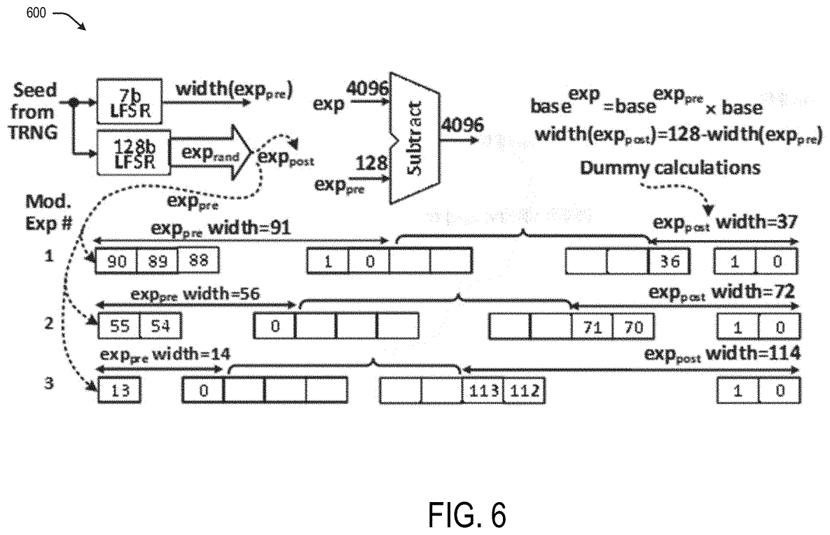

FIG. 6 is a schematic illustration of a process for exponent magnitude and timing randomization, according to embodiments. Referring to FIG. 6, in some examples a process 600 to randomize an exponent magnitude is implemented by operating the square-multiply-loop using a calculated exponent exp_{calc} obtained by subtracting expₚᵣₑ from the main exponent exp. Output base^{exp} is calculated as two partial exponentiations base^{exp}ₚᵣₑ and base^{exp}_{calc}, computed by the first and second loops respectively. The third expₚₒₛₜ loop operates on random dummy data, writing to registers that do not contribute to the final output. Finally, partial exponentiation results are multiplied to obtain baseₑₓₚ. Randomizing both exponent timing and magnitude ensures that n-way averaging to reduce measurement noise during single-trace attacks convolutes switching activities of true and random exponents, reducing signal-to-noise ratio (SNR) of the secret information. Similarly, averaging across bases in multi-trace attacks conflates exponent value across a search space of 2¹³⁵, attenuating information leakage in the averaged trace.

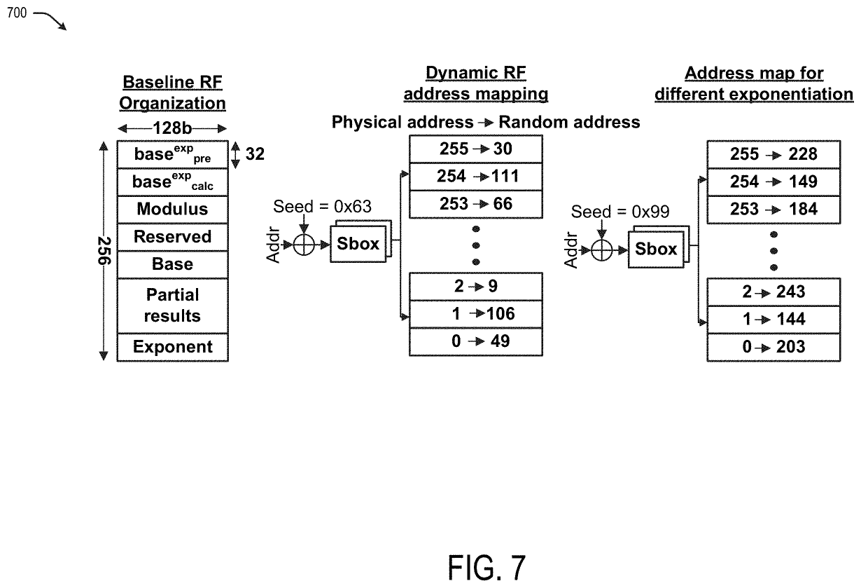

FIG. 7 is a schematic illustration of a process 700 for address randomization, according to embodiments. Referring to FIG. 7, in some examples a baseline register file is subjected to a dynamic addressing process to convert a physical address to a random address, and an address map is generated to map the physical address to the random address. A non-linear AES Sbox scrambles access patterns by mapping the physical address to a random address map. An 8b seed generated by an on-chip LFSR is XORed with the address and processed by Sbox to generate the random address. Before the next exponentiation operation, the contents in the register file are shuffled accordingly based on the new seed value. The address for shuffling is obtained by inverting the Sbox operation and XORing the resulting value with the new seed. This dynamic memory addressing incurs less than 0.005% area overhead with no performance impact.

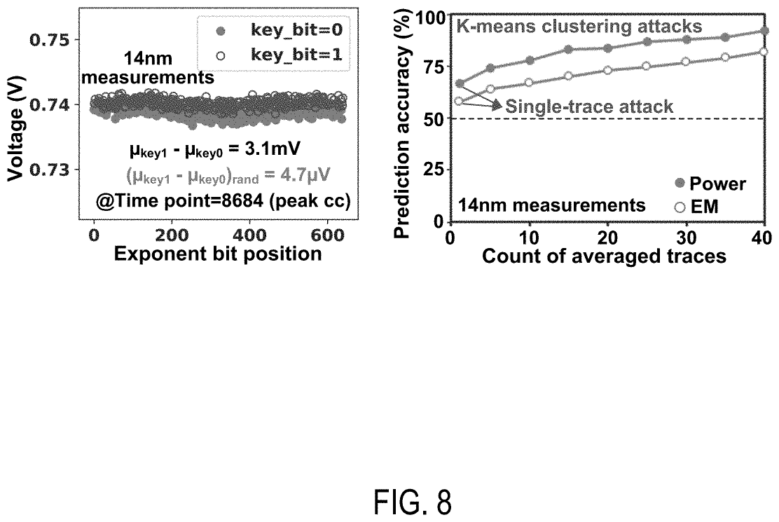

FIG. 8 is a set of graphs illustrating side channel attacks on an unprotected RSA processor. Referring to FIG. 8, correlation analysis of current and EM traces measured from a 14 nm CMOS prototype while executing 40 exponentiations on a conventional RSA processor indicates that peak correlation occurs during reduction operation at the end of square-multiply loop. Scatter plot of trace magnitudes reveals means-separation of 3.1 mV between exponent values 0 and 1, enabling reliable exponent binning. K-means clustering of voltage magnitudes at peak correlation point shows that exponent prediction accuracy improves from 68/59% for a single-trace attack to 91/80% for 40-way multi-trace power and EM attacks, respectively.

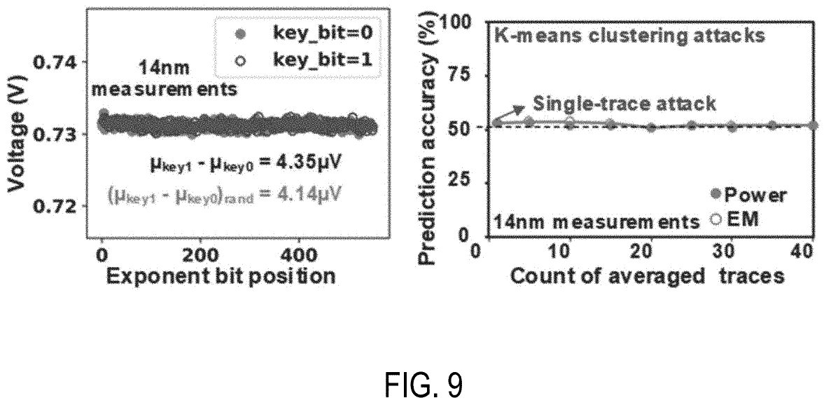

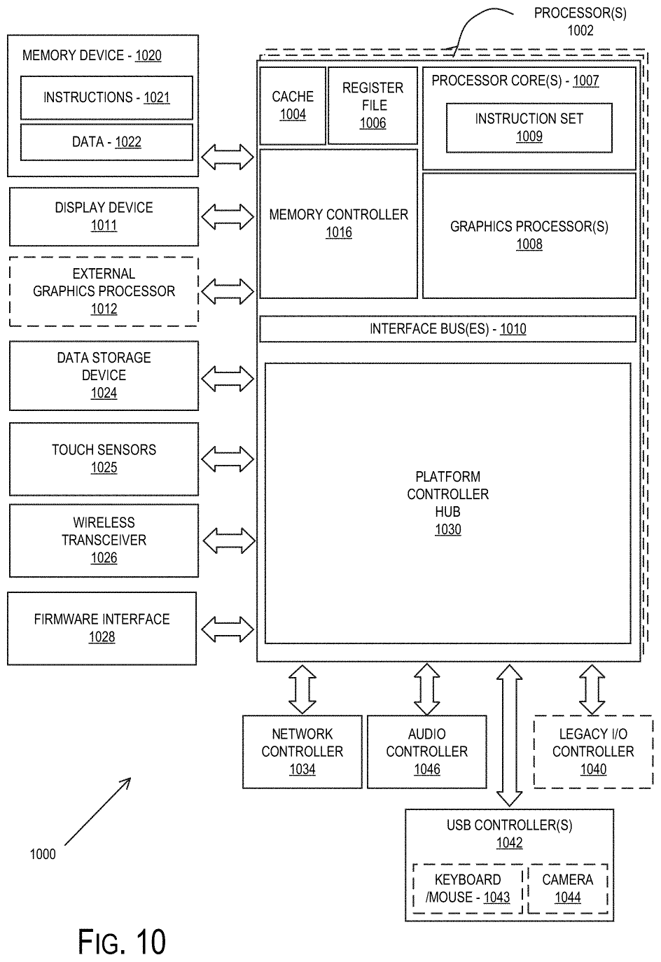

FIG. 9 is a set of graphs illustrating side channel attacks on a protected RSA processor, according to embodiments. Referring to FIG. 9, single and multi-trace power/EM attacks were repeated with exponent timing and magnitude randomizer enabled, where random expₚᵣₑ, exp_{calc} and expₚₒₛₜ were generated across noise reduction and multi-trace averaging. Scatter plot of voltage magnitudes for the SCA-resistant implementation shows a suppression in means separation of 711× time over conventional implementation, with the mean separation closer to a brute-force random binning of 4.12 μV. K-means clustering indicates prediction accuracy of 52% for a single-trace attack and converges to random guess accuracy of approximately 50% with multi-trace attacks.

FIG. 10 is a schematic illustration of an electronic device which may be adapted to implement an IP independent secure firmware load, according to embodiments. In various embodiments, the computing architecture 1000 may comprise or be implemented as part of an electronic device. In some embodiments, the computing architecture 1000 may be representative, for example of a computer system that implements one or more components of the operating environments described above. In some embodiments, computing architecture 1000 may be representative of one or more portions or components of a DNN training system that implement one or more techniques described herein. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 1000. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1000 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1000.

As shown in FIG. 10, the computing architecture 1000 includes one or more processors 1002 and one or more graphics processors 1008, and may be a single processor desktop system, a multiprocessor workstation system, or a server system having a large number of processors 1002 or processor cores 1007. In on embodiment, the system 1000 is a processing platform incorporated within a system-on-a-chip (SoC or SOC) integrated circuit for use in mobile, handheld, or embedded devices.

An embodiment of system 1000 can include, or be incorporated within a server-based gaming platform, a game console, including a game and media console, a mobile gaming console, a handheld game console, or an online game console. In some embodiments system 1000 is a mobile phone, smart phone, tablet computing device or mobile Internet device. Data processing system 1000 can also include, couple with, or be integrated within a wearable device, such as a smart watch wearable device, smart eyewear device, augmented reality device, or virtual reality device. In some embodiments, data processing system 1000 is a television or set top box device having one or more processors 1002 and a graphical interface generated by one or more graphics processors 1008.

In some embodiments, the one or more processors 1002 each include one or more processor cores 1007 to process instructions which, when executed, perform operations for system and user software. In some embodiments, each of the one or more processor cores 1007 is configured to process a specific instruction set 1009. In some embodiments, instruction set 1009 may facilitate Complex Instruction Set Computing (CISC), Reduced Instruction Set Computing (RISC), or computing via a Very Long Instruction Word (VLIW). Multiple processor cores 1007 may each process a different instruction set 1009, which may include instructions to facilitate the emulation of other instruction sets. Processor core 1007 may also include other processing devices, such a Digital Signal Processor (DSP).

In some embodiments, the processor 1002 includes cache memory 1004. Depending on the architecture, the processor 1002 can have a single internal cache or multiple levels of internal cache. In some embodiments, the cache memory is shared among various components of the processor 1002. In some embodiments, the processor 1002 also uses an external cache (e.g., a Level-3 (L3) cache or Last Level Cache (LLC)) (not shown), which may be shared among processor cores 1007 using known cache coherency techniques. A register file 1006 is additionally included in processor 1002 which may include different types of registers for storing different types of data (e.g., integer registers, floating point registers, status registers, and an instruction pointer register). Some registers may be general-purpose registers, while other registers may be specific to the design of the processor 1002.

In some embodiments, one or more processor(s) 1002 are coupled with one or more interface bus(es) 1010 to transmit communication signals such as address, data, or control signals between processor 1002 and other components in the system. The interface bus 1010, in one embodiment, can be a processor bus, such as a version of the Direct Media Interface (DMI) bus. However, processor busses are not limited to the DMI bus, and may include one or more Peripheral Component Interconnect buses (e.g., PCI, PCI Express), memory busses, or other types of interface busses. In one embodiment the processor(s) 1002 include an integrated memory controller 1016 and a platform controller hub 1030. The memory controller 1016 facilitates communication between a memory device and other components of the system 1000, while the platform controller hub (PCH) 1030 provides connections to I/O devices via a local I/O bus.

Memory device 1020 can be a dynamic random-access memory (DRAM) device, a static random-access memory (SRAM) device, flash memory device, phase-change memory device, or some other memory device having suitable performance to serve as process memory. In one embodiment the memory device 1020 can operate as system memory for the system 1000, to store data 1022 and instructions 1021 for use when the one or more processors 1002 executes an application or process. Memory controller hub 1016 also couples with an optional external graphics processor 1012, which may communicate with the one or more graphics processors 1008 in processors 1002 to perform graphics and media operations. In some embodiments a display device 1011 can connect to the processor(s) 1002. The display device 1011 can be one or more of an internal display device, as in a mobile electronic device or a laptop device or an external display device attached via a display interface (e.g., DisplayPort, etc.). In one embodiment the display device 1011 can be a head mounted display (HMD) such as a stereoscopic display device for use in virtual reality (VR) applications or augmented reality (AR) applications.

In some embodiments the platform controller hub 1030 enables peripherals to connect to memory device 1020 and processor 1002 via a high-speed I/O bus. The I/O peripherals include, but are not limited to, an audio controller 1046, a network controller 1034, a firmware interface 1028, a wireless transceiver 1026, touch sensors 1025, a data storage device 1024 (e.g., hard disk drive, flash memory, etc.). The data storage device 1024 can connect via a storage interface (e.g., SATA) or via a peripheral bus, such as a Peripheral Component Interconnect bus (e.g., PCI, PCI Express). The touch sensors 1025 can include touch screen sensors, pressure sensors, or fingerprint sensors. The wireless transceiver 1026 can be a Wi-Fi transceiver, a Bluetooth transceiver, or a mobile network transceiver such as a 3G, 4G, or Long Term Evolution (LTE) transceiver. The firmware interface 1028 enables communication with system firmware, and can be, for example, a unified extensible firmware interface (UEFI). The network controller 1034 can enable a network connection to a wired network. In some embodiments, a high-performance network controller (not shown) couples with the interface bus 1010. The audio controller 1046, in one embodiment, is a multi-channel high definition audio controller. In one embodiment the system 1000 includes an optional legacy I/O controller 1040 for coupling legacy (e.g., Personal System 2 (PS/2)) devices to the system. The platform controller hub 1030 can also connect to one or more Universal Serial Bus (USB) controllers 1042 connect input devices, such as keyboard and mouse 1043 combinations, a camera 1044, or other USB input devices.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

In various implementations, the computing device may be a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device may be any other electronic device that processes data or records data for processing elsewhere.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Some embodiments pertain to Example 1 that includes an apparatus comprising a processor to generate a random exponent having a fixed bit width, divide the random exponent into a pre-exponent portion and a post-exponent portion at a random bit position in the fixed bit width; and generate a cryptographic key using the pre-exponent portion and the post exponent portion.

Example 2 includes the subject matter of Example 1, further comprising a linear feedback shift register; a register file; an instruction decoder to decode a series of user instructions; and a controller to execute the series of user instructions.

Example 3 includes the subject matter of Examples 1 and 2, wherein the random exponent has a 128 bit fixed bit width; and the random bit position is determined by an output of the linear feedback shift register.

Example 4 includes the subject matter of Examples 1-3, the processor to execute a first square/multiply loop using the pre-exponent; execute a second square/multiply loop using a calculated exponent; and execute a third square/multiply loop using the post-exponent.

Example 5 includes the subject matter of Examples 1-4, wherein the first square/multiply loop exhibits a first latency determined by an input of the LFSR; and the second square/multiply loop exhibits a second latency determined by an input of the LFSR.

Example 6 includes the subject matter of Examples 1-5, wherein first square/multiply loop and the second square/multiply loop sum to a constant value.

Example 7 includes the subject matter of Examples 1-6, further comprising an address randomizer using a non-linear Sbox to randomize an address in the register file.

Some embodiments pertain to Example 8 that includes a processor implemented method comprising generating a random exponent having a fixed bit width; dividing the random exponent into a pre-exponent portion and a post-exponent portion at a random bit position in the fixed bit width; and generating a cryptographic key using the pre-exponent portion and the post exponent portion.

Example 9 includes the subject matter of Example 8, further comprising a linear feedback shift register; a register file; an instruction decoder to decode a series of user instructions; and a controller to execute the series of user instructions.

Example 10 includes the subject matter of Examples 8 and 9, wherein the random exponent has a 128 bit fixed bit width; and the random bit position is determined by an output of the linear feedback shift register.

Example 11 includes the subject matter of Examples 8-10, further comprising executing a first square/multiply loop using the pre-exponent; executing a second square/multiply loop using a calculated exponent; and executing a third square/multiply loop using the post-exponent.

Example 12 includes the subject matter of Examples 8-11, wherein the first square/multiply loop exhibits a first latency determined by an input of the LFSR; and the second square/multiply loop exhibits a second latency determined by an input of the LFSR.

Example 13 includes the subject matter of Examples 8-12, wherein first square/multiply loop and the second square/multiply loop sum to a constant value.

Example 14 includes the subject matter of Examples 8-13, further comprising randomizing an address in the register file using a non-linear Sbox.

Some embodiments pertain to Example 15, that includes at least one non-transitory computer readable medium having instructions stored thereon, which when executed by a processor, cause the processor to generate a random exponent having a fixed bit width; divide the random exponent into a pre-exponent portion and a post-exponent portion at a random bit position in the fixed bit width; and generate a cryptographic key using the pre-exponent portion and the post exponent portion.

Example 16 includes the subject matter of Example 15, further comprising a linear feedback shift register; a register file; an instruction decoder to decode a series of user instructions; and a controller to execute the series of user instructions.

Example 17 includes the subject matter of Examples 15 and 16, wherein the random exponent has a 128 bit fixed bit width; and the random bit position is determined by an output of the linear feedback shift register.

Example 18 includes the subject matter of Examples 15-17, further comprising instruction which, when executed by processor, cause the processor to execute a first square/multiply loop using the pre-exponent; execute a second square/multiply loop using a calculated exponent; and execute a third square/multiply loop using the post-exponent.

Example 19 includes the subject matter of Examples 15-18, further comprising instruction which, when executed by processor, wherein the first square/multiply loop exhibits a first latency determined by an input of the LFSR; and the second square/multiply loop exhibits a second latency determined by an input of the LFSR

Example 20 includes the subject matter of Examples 15-19, wherein first square/multiply loop and the second square/multiply loop sum to a constant value.

Example 21 includes the subject matter of Examples 15-20, wherein the processor is to randomize an address in the register file using a non-linear Sbox.

The details above have been provided with reference to specific embodiments. Persons skilled in the art, however, will understand that various modifications and changes may be made thereto without departing from the broader spirit and scope of any of the embodiments as set forth in the appended claims. The foregoing description and drawings are, accordingly, to be regarded in an illustrative rather than a restrictive sense.

What is claimed is:

1. An apparatus comprising a processor to:
generate a random exponent having a fixed bit width;
divide the random exponent into a pre-exponent portion and a post-exponent portion at a random bit position in the fixed bit width; and
generate a cryptographic key using the pre-exponent portion and the post exponent portion.

2. The apparatus of claim 1, further comprising:
a linear feedback shift register;
a register file;
an instruction decoder to decode a series of user instructions; and
a controller to execute the series of user instructions.

3. The apparatus of claim 2, wherein:
the random exponent has a 128 bit fixed bit width; and
the random bit position is determined by an output of the linear feedback shift register.

4. The apparatus of claim 3, the processor to:
execute a first square/multiply loop using the pre-exponent;
execute a second square/multiply loop using a calculated exponent; and
execute a third square/multiply loop using the post-exponent.

5. The apparatus of claim 3, wherein:
the first square/multiply loop exhibits a first latency determined by an input of the LFSR; and
the second square/multiply loop exhibits a second latency determined by an input of the LFSR.

6. The apparatus of claim 5, wherein first square/multiply loop and the second square/multiply loop sum to a constant value.

7. The apparatus of claim 2, further comprising:
an address randomizer using a non-linear Sbox to randomize an address in the register file.

8. A processor-implemented method, comprising:
generating a random exponent having a fixed bit width;
dividing the random exponent into a pre-exponent portion and a post-exponent portion at a random bit position in the fixed bit width; and
generating a cryptographic key using the pre-exponent portion and the post exponent portion.

9. The method of claim 8, wherein the processor comprises:
a linear feedback shift register;
a register file;
an instruction decoder to decode a series of user instructions; and
a controller to execute the series of user instructions.

10. The method of claim 9, wherein:
the random exponent has a 128 bit fixed bit width; and
the random bit position is determined by an output of the linear feedback shift register.

11. The method of claim 10, further comprising:
executing a first square/multiply loop using the pre-exponent;
executing a second square/multiply loop using a calculated exponent; and
executing a third square/multiply loop using the post-exponent.

12. The method of claim 10, wherein:
the first square/multiply loop exhibits a first latency determined by an input of the LFSR; and
the second square/multiply loop exhibits a second latency determined by an input of the LFSR.

13. The method of claim 12, wherein the first square/multiply loop and the second square/multiply loop sum to a constant value.

14. The method of claim 13, further comprising:
randomizing an address in the register file using a non-linear Sbox.

15. At least one non-transitory computer readable medium having instructions stored thereon, which when executed by a processor, cause the processor to:
generate a random exponent having a fixed bit width;
divide the random exponent into a pre-exponent portion and a post-exponent portion at a random bit position in the fixed bit width; and
generate a cryptographic key using the pre-exponent portion and the post exponent portion.

16. The computer readable medium of claim 15, wherein the processor comprises:
a linear feedback shift register;
a register file;
an instruction decoder to decode a series of user instructions; and
a controller to execute the series of user instructions.

17. The computer readable medium of claim 16, wherein:
the random exponent has a 128 bit fixed bit width; and
the random bit position is determined by an output of the linear feedback shift register.

18. The computer readable medium of claim 17, further comprising instruction which, when executed by processor, cause the processor to:
execute a first square/multiply loop using the pre-exponent;
execute a second square/multiply loop using a calculated exponent; and
execute a third square/multiply loop using the post-exponent.

19. The computer readable medium of claim 17, wherein:
the first square/multiply loop exhibits a first latency determined by an input of the LFSR; and
the second square/multiply loop exhibits a second latency determined by an input of the LFSR.

20. The computer readable medium of claim 19, wherein first square/multiply loop and the second square/multiply loop sum to a constant value.

21. The computer readable medium of claim 6, wherein the processor is to:
randomize an address in the register file using a non-linear Sbox.
